(19) United States
(12) Patent Application Publication
(10) Pub. No.: US 2016/0270421 A1
(43) Pub. Date: Sep. 22, 2016

(54) Process for the Production of Coffee Extract and Coffee

(71) Applicant: Jeremy L. Gamble, Jacksonville Beach, FL (US)

(72) Inventor: Jeremy L. Gamble, Jacksonville Beach, FL (US)

(21) Appl. No.: 15/071,664

(22) Filed: Mar. 16, 2016

Related U.S. Application Data
(60) Provisional application No. 62/133,561, filed on Mar. 16, 2015.

(51) Int. Cl. A23F 5/36; A23F 5/26

(52) U.S. Cl. CPC A23F 5/36; A23F 5/26

(57) ABSTRACT

A process for producing coffee extract and coffee producing by producing a liquid stock by combining water and whole coffee beans and heating the combination under pressure, then filtering the liquid stock to separate the liquid stock from the whole beans; producing a remouillage by replenishing lost liquid in the liquid stock, heating the liquid stock, adding semi-coarse ground coffee, cooling, and then straining to separate the remouillage from the semi-coarse ground coffee; and producing a coffee extract by replenishing lost liquid in the remouillage, adding coarse ground coffee, refrigerating and filtering to separate the coffee extract from the coarse ground coffee.

This application claims the benefit of U.S. Provisional Patent Application Ser. No. 62/133,561, filed Mar. 16, 2015.

### BACKGROUND OF THE INVENTION

The process relates in general to methods and processes for producing coffee, and more particularly relates to methods and processes for the production of a concentrated coffee liquid.

The primary focus in the production of coffee is on quality, i.e., the taste delivered to the consumer. As with any consumer product, delivered quality must be counterbalanced against the cost of delivering that quality. Multiple variables determine the delivery cost of coffee to the consumer, such as the choice of coffee bean, method of delivery (store front, drive-thru, restaurant service), process methodology, storage and transportation. The consumption of coffee is such an immense market that tiny reductions in costs translate into vastly increased profit margins.

It is an object of this invention to provide a process for producing a concentrated liquid coffee extract that significantly reduces the cost of producing a cup of coffee without sacrificing quality. It is a further object to provide such a process wherein the concentrated liquid coffee extract is readily storable and transportable. It is a further object to provide such as process that produces a high quality coffee for consumption. It is a further object to provide such a process that is scalable to produce large quantities of coffee extract.

### SUMMARY OF THE INVENTION

The invention is a process for the production of coffee extract and consumable coffee that results in a higher yield of coffee from a given quantity of coffee beans without sacrificing taste and other desirable qualities. The process comprises producing a liquid coffee extract by first producing a pressure stock, then a French press remouillage, and then a cold brew toddy. A small quantity the coffee extract is then mixed with water to produce the consumable coffee.

The step of producing a pressure stock begins with whole coffee beans processed under heat and pressure to produce a liquid stock that is then filtered. The step of producing a French press remouillage involves adding water to replenish lost liquid volume, heating the liquid stock, adding a quantity of semi-ground coffee, cooling to room temperature and filtering. The step of producing a cold brew toddy involves adding water to the remouillage to replenish lost liquid volume, adding coarse ground coffee, refrigerating and filtering.

In alternative language, the invention is a coffee extract and coffee producing process comprising the steps of producing a liquid stock by combining water and whole coffee beans and heating the combination under pressure, then filtering said liquid stock to separate said liquid stock from said whole beans; producing a remouillage by replenishing lost liquid in said liquid stock, heating said liquid stock, adding semi-coarse ground coffee, cooling, and then straining to separate said remouillage from said semi-coarse ground coffee; and producing a coffee extract by replenishing lost liquid in said remouillage, adding coarse ground coffee, refrigerating and filtering to separate said coffee extract from said coarse ground coffee.

In more detail, the process wherein said step of producing a liquid stock comprises combining approximately 2 gallons of water and approximately 16-24 ounces of whole coffee beans, or equivalent multiples thereof; and heating the combination to create a pressure of approximately 10-20 psi and holding for approximately 50-60 minutes; wherein said step of producing a remouillage comprises heating said liquid stock to a temperature of approximately 190-208 degrees F. and adding approximately 24-32 ounces of semi-coarse ground coffee, or a multiple equal to any said multiple utilized in the step of producing a liquid stock, brewing for a period of approximately 3-6 minutes and cooling to room temperature; and wherein said step of producing a coffee extract comprises adding approximately 16-24 ounces of coarse ground coffee, or a multiple equal to any said multiple utilized in the step of producing a liquid stock, and refrigerating to approximately 39-41 degrees F. for approximately 8-12 hours. Furthermore, the process further comprising the step of adding water to said coffee extract to produce coffee and/or wherein approximately 6-6.5 ounces of water is added to approximately 1.5-2 ounces of said coffee extract.

Alternatively, a coffee extract and coffee producing process comprising the steps of producing a liquid stock by combining a liquid volume of approximately 2 gallons of water and a weight amount of approximately 16-24 ounces of whole coffee beans and heating the combination under pressure to approximately 10-20 psi, holding at pressure for approximately 50-60 minutes, then filtering said liquid stock to separate said liquid stock from said whole beans; producing a remouillage by adding water to said liquid stock to create a total liquid volume of 2 gallons, heating said liquid stock to a temperature of approximately 190-208 degrees F., adding a weight amount of approximately 24-32 ounces of semi-coarse ground coffee, brewing for a period of approximately 3-6 minutes, cooling to room temperature, and then straining to separate said remouillage from said semi-coarse ground coffee; producing a coffee extract by adding water to said remouillage to create a total liquid volume of 2 gallons, adding a weight amount of approximately 16-24 ounces of coarse ground coffee, refrigerating to approximately 39-41 degrees F. for approximately 8-12 hours and filtering to separate said coffee extract from said coarse ground coffee.

In addition, the process wherein said liquid volumes and said weight amounts are increased by a multiplier or percentage such that the volume of coffee extract produced is increased and/or further comprising the step of adding water to said coffee extract to produce coffee, and/or wherein approximately 6-6.5 ounces of water is added to approximately 1.5-2 ounces of said coffee extract.

### BRIEF DESCRIPTION OF THE DRAWINGS

FIG. 1 is a flow chart illustrating a representative and preferred embodiment of the process for producing the concentrated liquid coffee extract. The flow chart provides a summary of the process of the invention using representative numbers for volume and amount, and the numerical variables are not meant to be limiting.

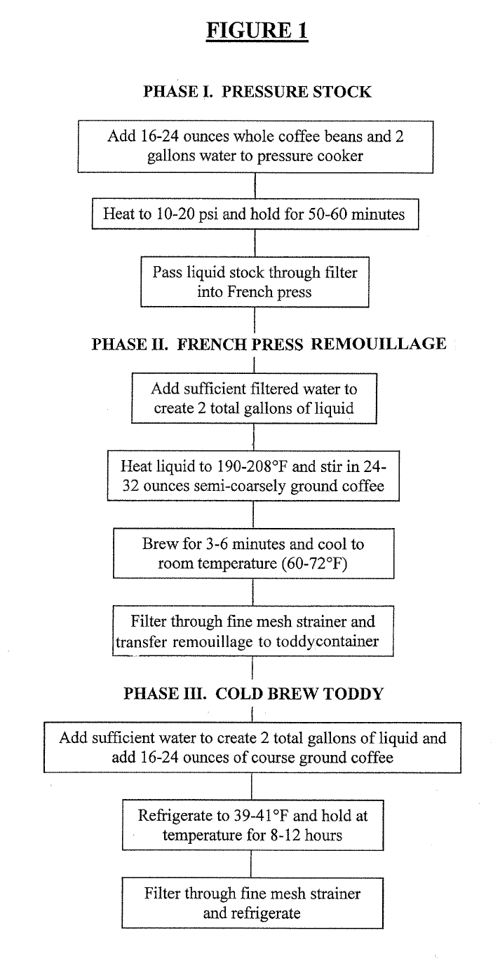

### DETAILED DESCRIPTION OF THE INVENTION

The process will be described herein in terms of pounds and ounces for solid components and gallons for liquid components. The given weights and volumes illustrate and establish necessary weight to volume ratios and are not meant to be limiting, as the weights and volumes are scalable in order to produce larger quantities of concentrated liquid coffee extract. Thus, the process is scalable in equal increases in weights and volumes, whether as a percentage or as multiples, such that the ratios remain the same. Likewise, conversion into different weights and volumes (e.g., grams and milliliters) is not precluded. Water utilized in this process is most preferably filtered or purified. The term “extract” as used herein refers to a liquid composition.

The term “coarse” shall be taken herein to mean ground coffee beans having a particle sizes greater than approximately 1.25 mm up to approximately 1.75 mm. The term “semi-coarse” shall be taken herein to mean ground coffee beans having a particle sizes greater than approximately 0.75 mm up to approximately 1.25 mm.

The process occurs and is described in three primary phases or steps. Phase or step one is the process methodology for producing a pressure stock. Phase or step two is the process for taking the pressure stock and producing a French press remouillage. Phase or step three is the process of taking the French press remouillage and producing a cold brew toddy, i.e., the concentrated liquid coffee extract. Production of coffee for actual consumption is then accomplished by adding a large quantity of water to a small quantity of the concentrated liquid coffee extract. One important feature of the process is that the volume of liquid present during each of the three processing phases is maintained at the same volume. Any liquid lost in a prior phase from evaporation, absorption or the like is replenished prior to initiating the subsequent phase. More simply stated, a starting volume of X gallons results in the production of X gallons of concentrated liquid coffee extract. This methodology safeguards the final product from being over-concentrated and over-caffeinated.

In the first step of the process, whole coffee beans and water are combined in a pressure cooker apparatus at a ratio of approximately 16-24 ounces of whole coffee beans to two gallons of water. Cold water at a preferred temperature of approximately 40° F. is added to the beans. The pressure cooker is then sealed and the temperature is slowly increased to obtain a pressure of approximately 10-20 psi, which is typically obtained at about 250-260° F. The contents are now held for approximately 50-60 minutes at this pressure. The liquid pressure stock is then separated from the solids by passing it through a filter. The pressure stock is then put into a French press device.

In the second step of the process, water is added to the pressure stock to obtain a total liquid volume of two gallons, i.e., sufficient water is added such that the total volume approximately equals the starting volume. The diluted pressure stock liquid is then heated to approximately 190-208° F. and 24-32 ounces of semi-coarse ground coffee is added and held at this temperature for approximately 3 to 6 minutes. The liquid is then forced through a fine mesh strainer filter and allowed to cool to room temperature (approximately 60-72° F.) to produce a remouillage. This French press remouillage is then introduced to a container for the third process step.

In the third step of the process, water is added to the French press remouillage to again obtain a total liquid volume approximately equal to the starting volume of two gallons. 16-24 ounces of coarse ground coffee is then added to the liquid in the container. The mixture is then refrigerated to a temperature of approximately 39-41° F. and held at temperature for approximately 8-12 hours. The liquid is then passed through a fine mesh strainer filter to separate the solids.

This liquid product from step three, which may be referred to as a cold brew toddy, is the concentrated liquid coffee extract. It is stored and transported in a refrigerated environment until ready for use. Liquid coffee for consumption is then produced by adding hot water to the concentrated liquid coffee extract at a ratio of approximately 6 to 6.5 ounces of hot water to approximately 1.5 to 2 ounces of concentrated liquid coffee extract, depending on the desired strength of the coffee to be consumed, to produce an 8 ounce cup of coffee. For stronger coffee, the volume of water is decreased and/or the volume of coffee extract is increased. For weaker coffee, the volume of water is increased and/or the volume of coffee extract is decreased.

For commercial production, the process is fully scalable, such that the amounts and volumes will be greatly increased. In addition, it is likely that all filtering will occur under pressure due to the larger volume of liquid being processed.

Under current methods of producing coffee for consumption, a pound of coffee beans will typically yield approximately 42-45 cups of coffee after being ground and brewed. In contrast, a pound of coffee beans utilized in the methodology as described herein will produce about 57-60 cups of coffee, an increase in yield of approximately 35-40%. This increase is accomplished without sacrificing quality and taste characteristics (i.e., the process preserves acidity, body, aroma, roasted and regional bean profiles). The coffee extract is readily transportable and storable.

As previously mentioned, the process is scalable by altering the weights of solids and volumes of liquids so as to maintain the proper ratios throughout the process. This may be accomplished by percentages of multiplication. Thus, while the process is set forth and illustrated with a representative starting volume of 16-24 ounces of whole coffee beans and 2 gallons of water, these amounts could both be increased for example by a factor of 10 (160-240 ounces of beans and 20 gallons of water), by 50% (24-36 ounces of beans and 3 gallons of water), etc., with corresponding increases in other solids and liquids, to produce a larger amount of coffee extract.

The descriptive language set forth above is for purposes of disclosure and enablement, and is not meant be limiting. The true scope and definition of the inventive process is to be as set forth in the following claims.

I claim:

1. A coffee extract and coffee producing process comprising the steps of:
producing a liquid stock by combining water and whole coffee beans and heating the combination under pressure, then filtering said liquid stock to separate said liquid stock from said whole beans;
producing a remouillage by replenishing lost liquid in said liquid stock, heating said liquid stock, adding semi-coarse ground coffee, cooling, and then straining to separate said remouillage from said semi-coarse ground coffee;
producing a coffee extract by replenishing lost liquid in said remouillage, adding coarse ground coffee, refrigerating and filtering to separate said coffee extract from said coarse ground coffee.

2. The process of claim 1, wherein said step of producing a liquid stock comprises combining approximately 2 gallons of water and approximately 16-24 ounces of whole coffee beans, or equivalent multiples thereof; and heating the combination to create a pressure of approximately 10-20 psi and holding for approximately 50-60 minutes.

3. The process of claim 2, wherein said step of producing a remouillage comprises heating said liquid stock to a temperature of approximately 190-208 degrees F. and adding approximately 24-32 ounces of semi-coarse ground coffee, or a multiple equal to any said multiple utilized in the step of producing a liquid stock, brewing for a period of approximately 3-6 minutes and cooling to room temperature.

4. The process of claim 3, wherein said step of producing a coffee extract comprises adding approximately 16-24 ounces of coarse ground coffee, or a multiple equal to any said multiple utilized in the step of producing a liquid stock, and refrigerating to approximately 39-41 degrees F. for approximately 8-12 hours.

5. The process of claim 1, further comprising the step of adding water to said coffee extract to produce coffee.

6. The process of step 5, wherein approximately 6-6.5 ounces of water is added to approximately 1.5-2 ounces of said coffee extract.

7. A coffee extract and coffee producing process comprising the steps of:
producing a liquid stock by combining a liquid volume of approximately 2 gallons of water and a weight amount of approximately 16-24 ounces of whole coffee beans and heating the combination under pressure to approximately 10-20 psi, holding at pressure for approximately 50-60 minutes, then filtering said liquid stock to separate said liquid stock from said whole beans;
producing a remouillage by adding water to said liquid stock to create a total liquid volume of 2 gallons, heating said liquid stock to a temperature of approximately 190-208 degrees F., adding a weight amount of approximately 24-32 ounces of semi-coarse ground coffee, brewing for a period of approximately 3-6 minutes, cooling to room temperature, and then straining to separate said remouillage from said semi-coarse ground coffee;
producing a coffee extract by adding water to said remouillage to create a total liquid volume of 2 gallons, adding a weight amount of approximately 16-24 ounces of coarse ground coffee, refrigerating to approximately 39-41 degrees F. for approximately 8-12 hours and filtering to separate said coffee extract from said coarse ground coffee.

8. The process of claim 7, wherein said liquid volumes and said weight amounts are increased by a multiplier such that the volume of coffee extract produced is increased.

9. The process of claim 8, wherein said liquid volumes and said weight amounts are increased by a percentage such that the volume of coffee extract produced is increased.

10. The process of claim 7, further comprising the step of adding water to said coffee extract to produce coffee.

11. The process of claim 10, wherein approximately 6-6.5 ounces of water is added to approximately 1.5-2 ounces of said coffee extract.
